(19) United States
(12) Patent Application Publication
(10) Pub. No.: US 2014/0351679 A1
(43) Pub. Date: Nov. 27, 2014

(54) SYSTEM AND METHOD FOR CREATING AND/OR BROWSING DIGITAL COMICS

(71) Applicant: Sony Corporation, Minato-ku (JP)

(72) Inventor: Hiroaki Tobita, Paris (FR)

(73) Assignee: Sony Corporation, Minato-ku (JP)

(21) Appl. No.: 14/283,359

(22) Filed: May 21, 2014

(30) Foreign Application Priority Data
May 22, 2013 (EP) 13168727.9

(51) Int. Cl. G06F 17/21; G06F 17/22

(52) U.S. Cl. CPC G06F 17/211; G06F 17/2247
USPC 715/202

(57) ABSTRACT

A system for creating a digital comic comprises a page processor configured to generate frames and the layout of frames that form pages of a digital comic including one or more multi-storylines each including two or more storylines and to provide selection elements in one or more frames allowing a user of the digital comic to select a storyline from among the two or more storylines of a multi-storyline associated with a frame containing selection elements. An edit processor is provided that is configured to generate comic content of the frames.

### BACKGROUND

1. Field of the Disclosure

The present disclosure relates to a system and a method for creating a digital comic as well as a system and a method for browsing in a digital comic. The present disclosure relates to a digital comic as well as a recording medium storing such a digital comic.

2. Description of Related Art

A comic is one of the most famous and popular form to visualize a story effectively. Comics are realizable not only as a paper material in magazines and newspapers, but also as e-book contents in PC and cellular phones. Many e-book stores nowadays provide digital comics and a wide variety of devices supporting applications to read comics are also available. In comparison to an analog comic that is printed onto a paper, a digital comic provides several advantages. Especially, colorization techniques can be applied for digital comic to edit the color of the comic contents. In the future, it is predictable that the quantity of digital comic will increase and people can read digital comic with a wide variety of devices.

However, current digital comics have disadvantages. Most digital comics are published just by digitalizing analog comic, so that digital comics have the same features of analog comics that have single storylines and are constructed by characteristic elements (e.g., character, speech bubble, background, and effect) set along with the storyline. Furthermore, the interaction is simply to change pages or frames from current to next.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly or impliedly admitted as prior art against the present disclosure.

### SUMMARY

It is an object to provide a system and a method for creating a digital comic as well as a system and a method for browsing in a digital comic having a more dynamic format and interaction compared to conventional digital comics and being useful for a wide variety of visualizations and applications. It is a further object to provide a corresponding digital comic and a recording medium storing such a digital comic.

According to an aspect there is provided a system for creating a digital comic, comprising
a page processor configured to generate frames and the layout of frames that form pages of a digital comic including one or more multi-storylines each including two or more storylines and to provide selection elements in one or more frames allowing a user of the digital comic to select a storyline from among the two or more storylines of a multi-storyline associated with a frame containing selection elements, and
an edit processor configured to generate comic content of the frames.

According to a further aspect there is provided a A system for browsing in a digital comic, comprising
a browser configured to present and traverse comic content of frames that form pages of a digital comic including one or more multi-storylines each including two or more storylines and to present selection elements in one or more frames allowing a user of the digital comic to select a storyline from among the two or more storylines of a multi-storyline associated with a frame containing selection elements, and
a selecting unit configured to allow a user to actuate a selection element when presented to thus select a storyline from among the two or more storylines of a multi-storyline.

According to still further aspects a computer program comprising program means for causing a computer to carry out the steps of the methods disclosed herein, when said computer program is carried out on a computer, as well as a non-transitory computer-readable recording medium that stores therein a computer program product, which, when executed by a processor, causes the methods disclosed herein to be performed are provided.

According to still further aspect a digital comic is provided comprising
comic content included in frames that form pages of a digital comic including one or more multi-storylines each including two or more storylines,
selection elements in one or more frames allowing a user of the digital comic to select a storyline from among the two or more storylines of a multi-storyline associated with a frame containing selection elements.

Preferred embodiments are defined in the dependent claims. It shall be understood that the disclosed methods, the disclosed digital comic, the disclosed computer program and the disclosed computer-readable recording medium have similar and/or identical preferred embodiments as the claimed systems and as defined in the dependent claims.

One of the aspects of the present disclosure is an interactive system enabling users to develop both the format and interaction of a digital comic (also referred to as comic book hereinafter). The proposed digital multi-storyline comic allows users to create unique digital comics that have multiple (two or more) storylines, browse it, and apply it. Digital contents are important for communication through the network, so the proposed digital comics are effective for new communication. Thus, the proposed system and method change the digital comic environment for readers and creators. The system allows readers to choose one story from several storylines such as different events and endings like bad, fun, or happy ends. Further, the system allows creators to test several storylines based on the contents. Generally, creators have several candidates of story or frame layouts to create comic books. However, in the conventional comic format, they have to choose one candidate to publish the comic. This is a kind of dilemma, which the proposed system and method solve effectively by using multi-storylines. By this approach, both the format and interaction of digital comics is enhanced, so it would change the paradigm of digital comic and timeline contents.

In preferred embodiments the proposed multi-storyline comic creation and browsing systems and methods provide the following three functions to treat digital comic with multi-storylines. To crate digital comics, a unique frame of digital comics has been design. Besides that the frame is used to set comic elements, it preferably contains several buttons (e.g., “add” and “select” buttons) to add new storylines and select one of storylines. Thus, users can create new storylines and select one of the storylines by clicking a button (or another selecting element provided for this purpose).

The selecting element (e.g. buttons) may also work to browse comic books. To develop the created contents, the system preferably provides several visualizations of created comic books. The system may publish created comic books as image or PDF file, and in addition it may treat the created process, in particular elements of the created digital comic, as both XML file and images. Thus, it is easy to share and exchange not only the created comic, but also the created process. In summary, by using the proposed approach, both the format and interaction of digital comics is enhanced, so it changes the paradigm of digital comic and timeline contents. Further, more flexible and useful formats are used to make digital comics more interesting and provide more fun to the users.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A-1E illustrate the proposed interaction and format,

FIG. 2 shows a conventional digital comic,

FIGS. 3A-3B show two comic creation modes according to the present disclosure,

FIGS. 4A-4H show how to set a multi-storyline interactively in the page mode,

FIGS. 5A-5C illustrate the use of several templates for creating a digital comic,

FIGS. 6A-6B show two comic browsing modes according to the present disclosure,

FIGS. 7A-7B show two examples of a digital comic according to the present disclosure having a different layout

FIGS. 8A-8B show the tree structure and an XML file of a digital comic according to the present disclosure,

FIG. 9 shows an example of contents creation of a digital comic according to the present disclosure,

FIG. 10 shows the creation of a visual novel game according to the present disclosure,

FIG. 11 shows a schematic diagram of a system for creating a digital comic according to the present disclosure,

FIG. 12 shows a schematic diagram of a system for browsing in a digital comic according to the present disclosure,

FIG. 13 shows a flow chart illustrating an embodiment of the main process for creating a digital comic,

FIGS. 14A-14B show a flow chart illustrating an embodiment of the steps for creating a new frame,

FIGS. 15A-15B show a flow chart illustrating an embodiment of the steps for displaying a frame related to a selection element, and

FIG. 16 shows hardware diagram of a processing system embodying aspects of this disclosure.

### DETAILED DESCRIPTION OF THE EMBODIMENTS

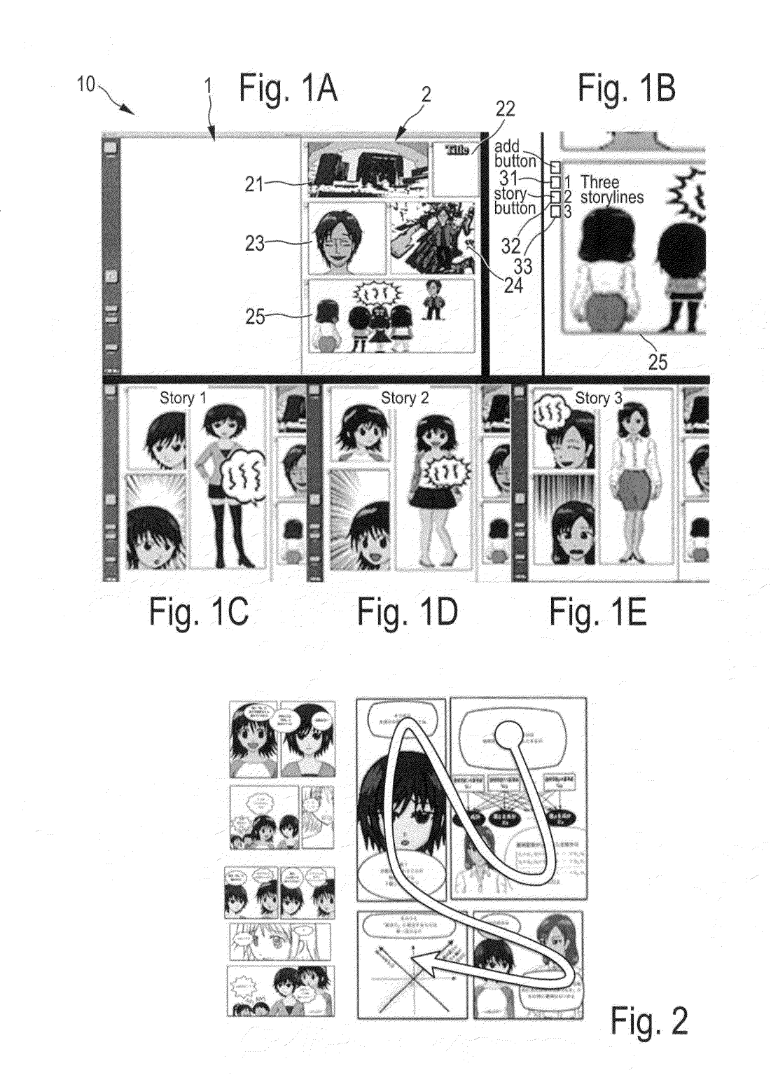

Referring now to the drawings, wherein like reference numerals designate identical or corresponding parts throughout the several views, FIG. 1 illustrates the proposed interaction and format roughly. FIG. 1A shows an overview of a multi-storyline digital comic 10 created by the proposed multi-storyline digital comic creation system. It comprises two pages 1, 2, wherein the first page 1 comprises a single (in this example empty) frame and the second page 2 comprises five frames 21, 22, 23, 24, 25. The fifth frame 25 comprises three rectangles 31, 32, 33 on the left side of the frame as illustrated in more detail in FIG. 1B. Said rectangles represent selection elements, here in the form of buttons that can be actuated by the user. Each rectangle is associated with a different storyline, so that users can choose one of them by clicking a button as shown in FIGS. 1C, 1D, 1E.

In conventional digital comics as shown in FIG. 2 each comic book has one storyline. In this case, the story line e.g. starts from the right-top frame and moves from the current to next frames by the end of the page.

Many comic creators have several stories such as different events and endings (e.g., happy or unhappy). To create and illustrate comic contents, comic creators currently basically consider several stories and choose the best story from them, so the most of them are not used. In order to use these non-used stories effectively, movie and TV animation may be used. In the movie and TV animations, spin-off stories or different endings may be shown. In view of this, a multi-storyline is an appropriate and useful representation means of a comic. With the proposed approach, readers can read different stories by the same format and interaction without having to change applications to read different stories.

Further, a multi-storyline system is useful for a wide variety of applications, because the created comic has a tree structure. For example, if users use the proposed approach in presentation, they can choose their slides depending on the reactions from audience. By integrating the proposed approach with game, users can create a sound (voice) game through comic format, as further explained in the following. The proposed system basically treats the tree structure as a comic, i.e. the multi-storyline comic may be organized in a tree structure, so that a comic based mind map is possible, as also described in the following.

In the following an exemplary implementation of the proposed multi-storyline system is described focusing on comic creation, comic browsing, and comic development.

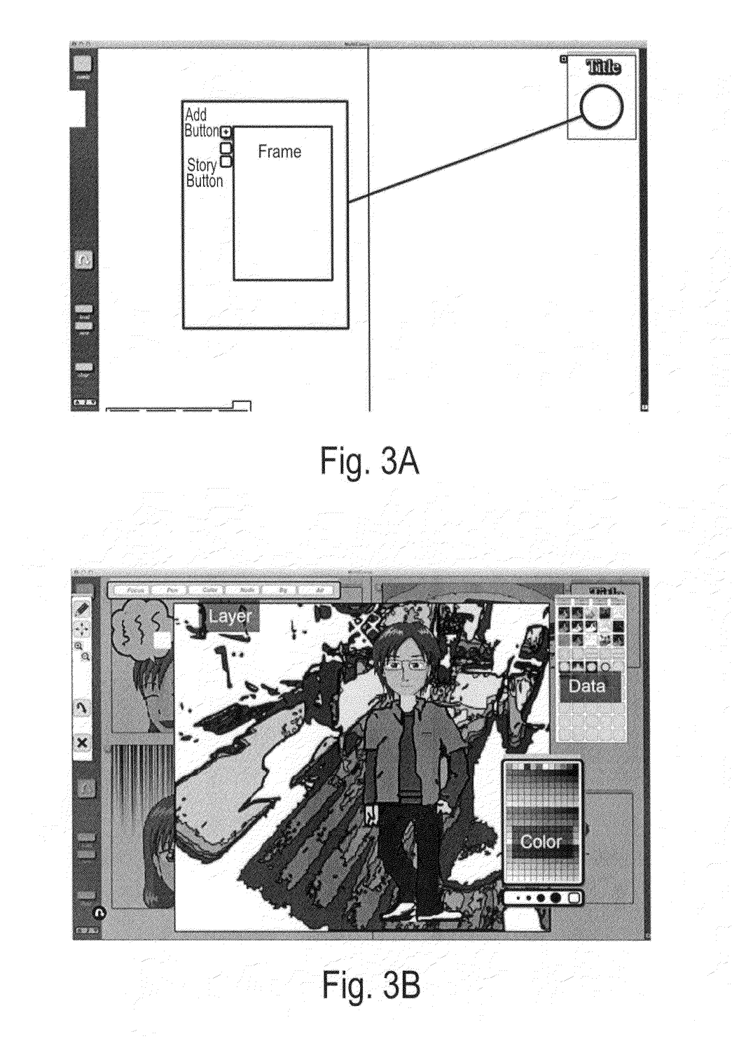

FIG. 3 shows two comic creation modes: page mode and edit mode. The page mode (FIG. 3A) is used to set a frame layout and comic elements roughly. The edit mode (FIG. 3B) is used to set each frame in detail. In the edit mode, the user can select different layers (e.g., focus line, rough, paint, character, background) to create a frame in detail.

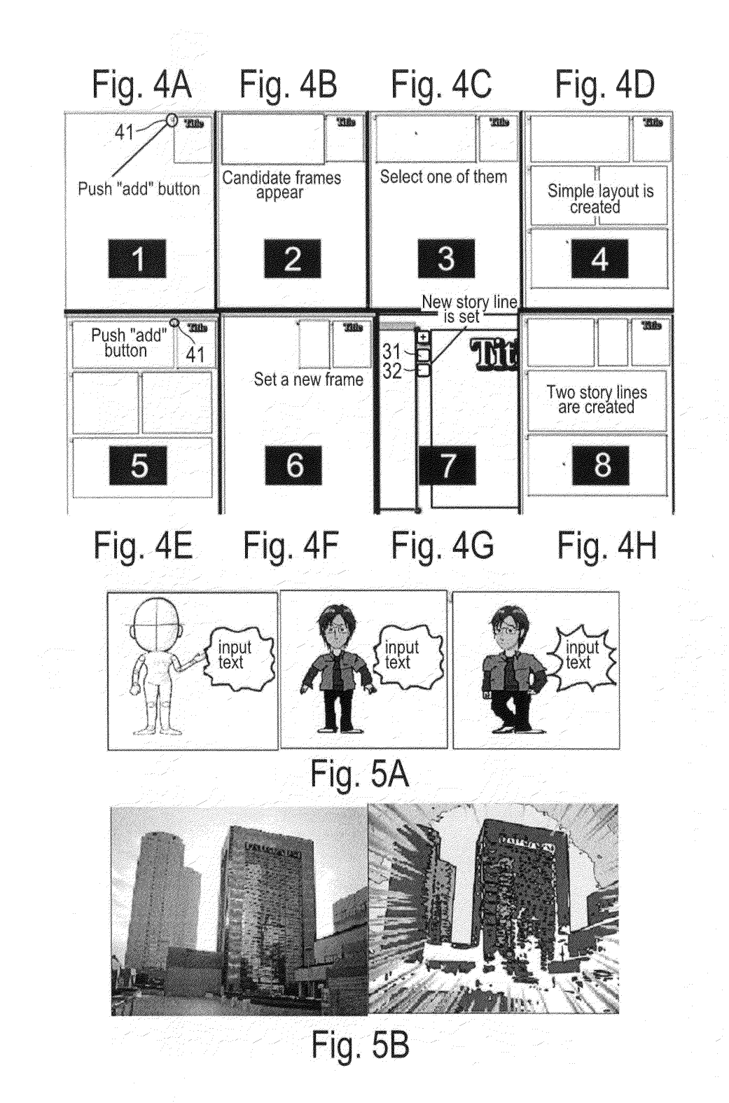

FIG. 4 shows an example of how to set a multi-storyline interactively in the page mode. When a user starts the system, a start node (i.e. a first frame) may appear in the right-top side of the workspace. In order to add a new fame, a user clicks the add button 41, representing another selection element, set on the left-top side of the current frame (FIG. 4A). Then, one or more candidate frames appear next to the frame (FIG. 4B), so a user selects one of them to set the next frame (FIG. 4C). By continuous setting of frames on a page, simple layout of comic books is created (FIG. 4D). Next, the user adds a different story based on the focus frame. When the user pushes the add button 41 of the start frame, following frames that are connected to the start frame disappear, and then a new frame appears next to the focus frame (FIGS. 4E, 4F). The frame is the start frame of another storyline. At the same time, a new rectangle (i.e. a selection element 32) that means a storyline appears. In this case, there are two story buttons (i.e. selection elements) 31, 32 on the right topside of the frame, so the user can see each storyline by clicking each button 31, 32. As a result, the second storyline is created (FIGS. 4G, 4H).

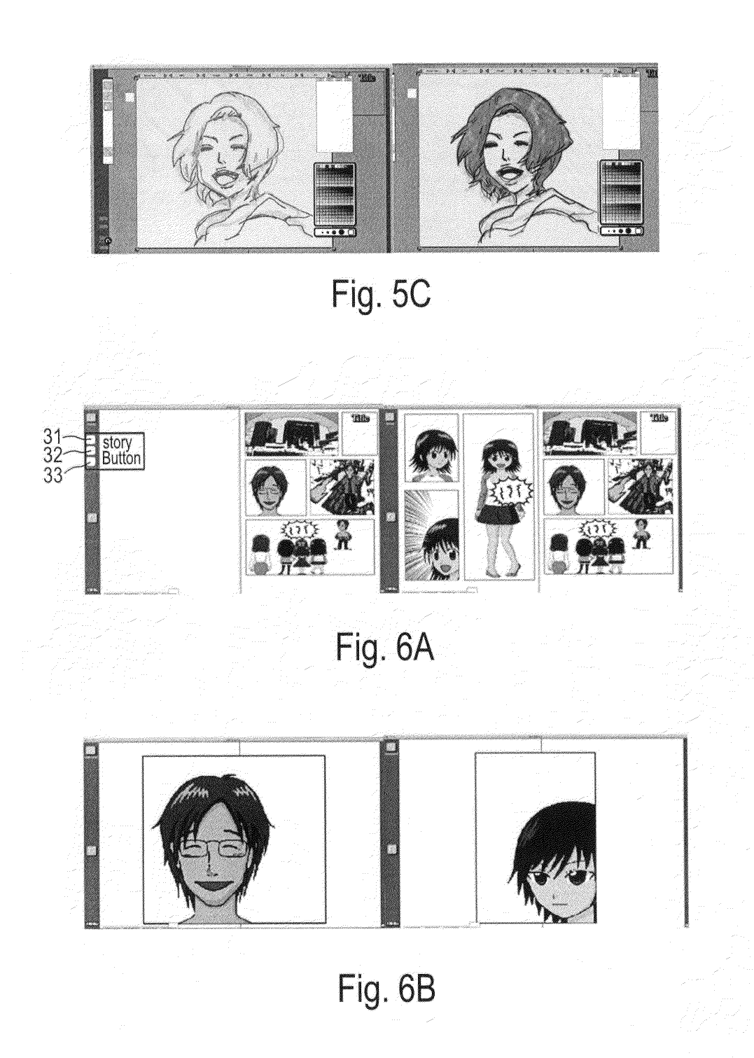

As the system may also provide several template data such as characters, speech bubbles, and effects, users can set them onto the frame area in the edit mode to create comic books as shown in FIGS. 5A, 5B. Especially for users who are not good at drawing, these kinds of data are useful because they can them just by dragging and dropping it onto the frame area. In the data area, users may upload images that they have in their device. As a result, a more practical comic frame is created without drawing. In addition, to make the comic element practical, the system may provide several edit functions such as using template data and drawing each element in detail as shown in FIG. 5C.

The proposed system for browsing in digital comics supports both page and frame modes. Switching from mode to mode may e.g. be performed by use of a selection element (for instance by clicking a mode switch button) or automatically, for instance in dependency on the display size. In the frame mode, several functions related with comic creation such as the add button disappear.

In the page mode for browsing users can see the entire page and read comic contents by turning pages and selecting a storyline. Page mode preferably works if a display of the device is enough large to show comic books. Compared to the comic creation mode, the system may modify the frame buttons: add and story buttons (representing selection elements). The add button has disappeared and story buttons 31, 32, 33 (FIG. 6A) move to the left side of the application window. The system shows frames until the system finds a frame that has multi-storyline. The user basically changes current to next pages just by clicking the edge of the application window. The system shows frames until the next multi-frame appears. FIG. 6A shows how to browse multi-storyline comic. When the next multi-frame appears, the system shows buttons on the edge of an application window, the number of buttons depending on the number of storylines. The user may choose the next storyline from them. If the system cannot find a multi-frame, it shows frames up to the end of the page and the story buttons are disappeared.

In the frame mode, users can see one frame or a part of a page in detail, and choose a storyline if the frame has several storylines (i.e. if the frame is the start of a multi-storyline). The frame mode preferably works if the device display is too small to see information. FIG. 6B shows an example of the frame mode on a small display device. If the frame has other stories (i.e. is the start of a multi-storyline), corresponding story buttons appear at the edge of the application window. Thus, the user selects one of them and moves to the next story.

For selecting a selection element (e.g. a story button) an appropriate selecting element is provided, e.g. a computer mouse, a touchscreen or a pointer which can be moved by a user (e.g. by moving the computer mouse by hand to move a pointer on the screen and use the pointer to actuate a selection element, e.g. a button, or by using the finger to move a pointer or directly press a (software) button on the screen) to the desired selection element to actuate it.

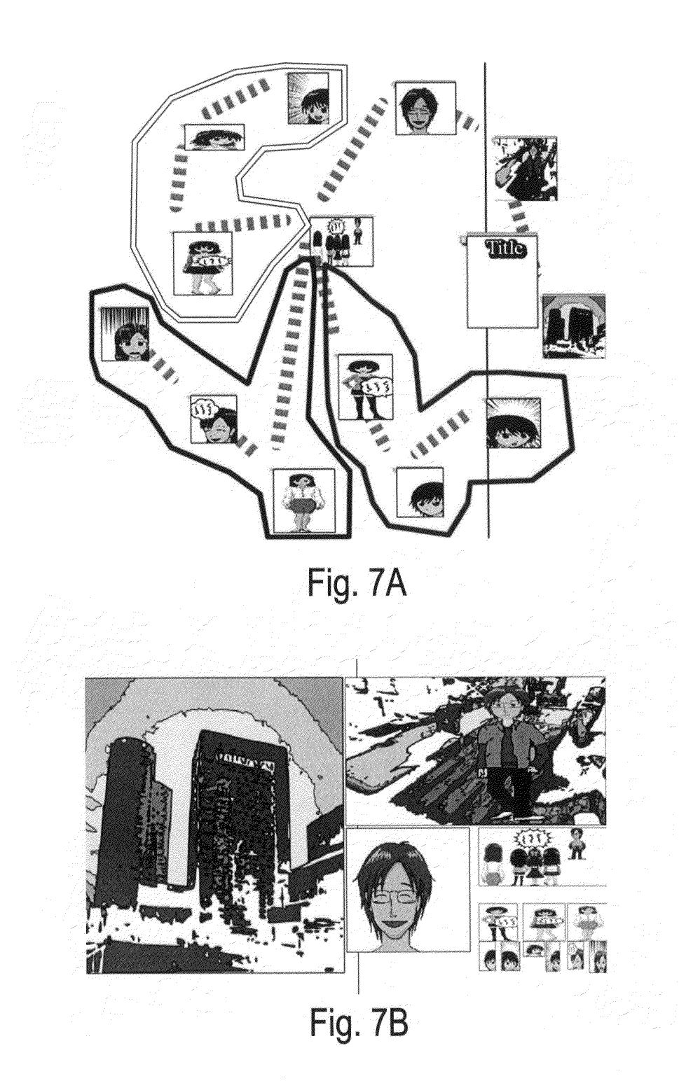

Multi-storyline comic books may be organized as a tree structure, so that information visualization techniques like focus and context are useful to see the comic books using different layouts. FIG. 7 shows two examples of different layouts that have the same comic contents. With a graph layout (FIG. 7A), users can see the relationship between nodes (frames) interactively. By the tree map, users can see the entire comic contents at the same time (FIG. 7B).

An exemplary implementation of the proposed multi-storyline comic system focuses on both visual elements and a data structure. In an embodiment flash (e.g. action script 3.0) is used to implement the proposed concept, so the system works as a web application that is useful for a wide variety of devices connected to the network. For the drawing function, Wacom API may be used which recognizes pen pressure, so users can draw with natural stroke and paint an area depending on the pressure whenever they use Wacom tablet.

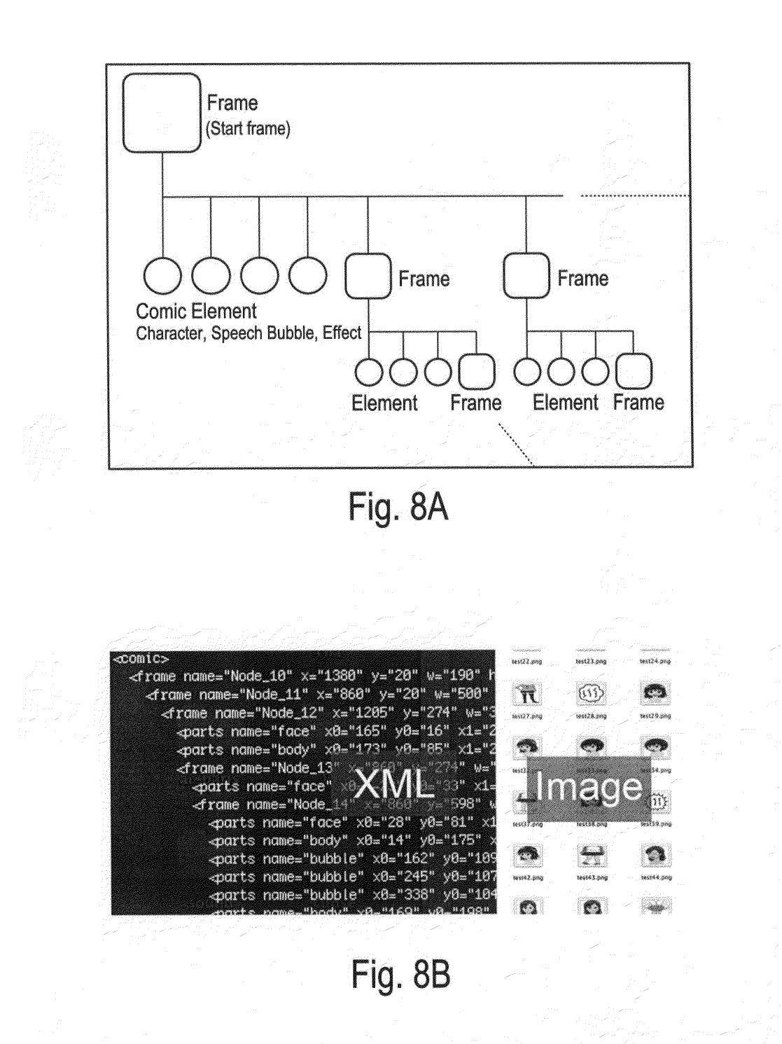

The system treats multi-comic books as a tree structure as shown in FIG. 8A. The start frame is the root node and a scene graph is created. Information of each element (e.g., position, size, and texture) is stored as XML file and images as illustrated in FIG. 8B. XML is widely used and many systems can support the format. Both XML file and images are simple, so users can edit multi-comics by using other software such as text editor and paint tools. Also, the system can treat multi-comic books as single PDF or image. In this case, according to one embodiment only user's selected storyline is published.

While conventional comic books support only one ending, by using the proposed approach, users can select the best ending. Also, comic creators may consider many storylines, frame layouts, and events through comic creation and cannot use all of them. By using the proposed approach, they can express all ideas onto comic pages. Further, users can easily create multi-storyline comic books, e.g. by providing different characters and events. It is possible to use only template data, but also to draw original characters. Further, new storylines can be added onto comic books created by another user. One advantage of the proposed system is that it is easy to collaborate with other users through comic creation. By using the proposed approach, creation and communication through comic is possible. Through the proposed system, users can share and exchange created comic books. Unlike conventional digital comic systems, the proposed system supports multi-storyline, so a user can add a different story based on comic books that another user created. Also, the proposed approach is also useful for a secondary use of digital contents and classic comic contents that are free from copyright.

The proposed approach is useful for other digital contents that have a single storyline or timeline. Although the main focus is to develop digital comic format and interaction, the proposed approach would be useful for movie and sound editing. Especially, the combination between movie and comic books is useful. By using the proposed approach, multi-timeline movie contents would be possible, and users could select the best timeline from several candidates.

Although the proposed system can provide multi-storyline, readers do not know each story in detail before reading. Hence, in an embodiment effective visual information is provided to support storyline selection. For such purposes, several techniques such as collective intelligence to add effective weight to each storyline are combined in an embodiment. The proposed system is preferably implemented as a web application, so it is easy to collect data about user preferences by known means. Thus, the system can determine the most popular storyline and add priority to each storyline. For example, if the results were reflected by the selection button' size or color, the change would be a kind of a hint for readers illustrating the popularity of each storyline.

The proposed approach is useful for a wide variety of applications such as mind maps, presentations and visual novel games.

Mind maps are generally used to organize ideas and thoughts by using text and images to create a graph layout. By using the proposed approach, each element of a mind map is a kind of a comic frame that contains characters and/or speech bubbles, so that a comic map is possible. Also, users can see their idea both in mind map and in multi-storyline comic formats, so these elements may make the mind map more fun and interesting. Comic map is easy to understand, so it is effective to share comic maps. Thus, the mind map becomes a kind of story instead of the overlook of the idea and thought.

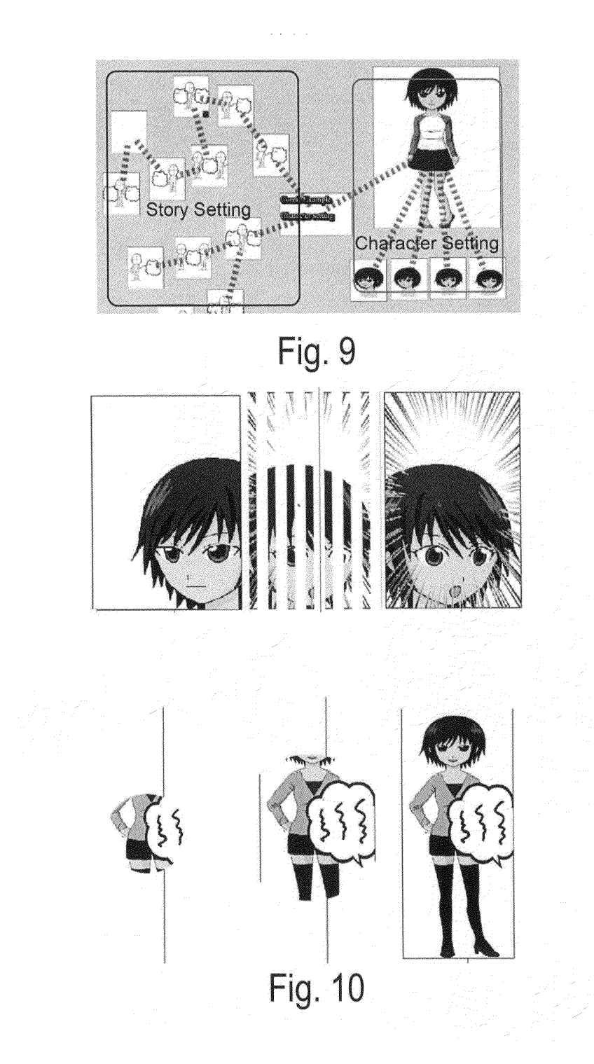

In addition, a comic map is also useful for comic creation. FIG. 9 shows an example of contents creation. In contents creation such as animation, comic books and game, a creator has to consider many things at the same time such as the story and character setting. In this example, the creator considers both story and character at the same time.

By using the proposed approach, presentation contents may have a multi-storyline, so that a presentation could be enhanced. Like multi-storyline comic creation, multi-storyline presentation is useful e.g. if a user has several candidates of presentation slides. Generally, presentation software supports one storyline. However, by integrating the proposed approach within a presentation and/or by including a presentation software, the presenter can change his/her presentation contents depending on the reaction from audiences or the atmosphere of the presentation room by selecting a suitable one of the multiple presentation storylines. The format is basically the format of a comic as outlined above, so that the user can distribute his/her presentation contents as a comic after the presentation.

The proposed format is basically static, so that modifications have to be made to create a realistic and rich 3D computer graphics game. However, with the proposed system, users can easily create a visual novel game as illustrated in FIG. 10. A visual novel game is an interactive fiction game, featuring mostly static graphics, wherein users may e. g. often choose one of several candidates to move to the next event. By using the proposed approach, a visual novel game is roughly created through comic creation, and then users set visual and sound effects to finish creating the game.

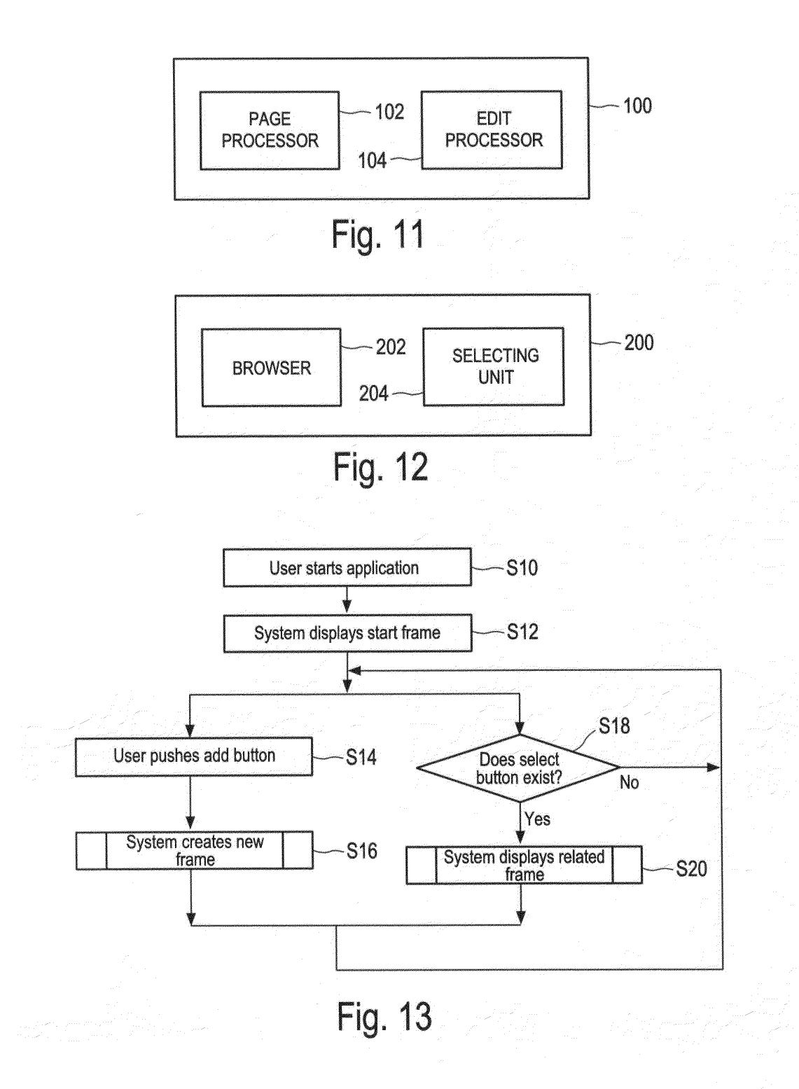

A schematic block diagram of the proposed system 100 for creating a digital comic is depicted in FIG. 11. It comprises a page processor 102 configured to generate frames and the layout of frames that form pages of a digital comic including one or more multi-storylines each including two or more storylines and to provide selection elements in one or more frames allowing a user of the digital comic to select a storyline from among the two or more storylines of a multi-storyline associated with a frame containing selection elements. Further, an edit processor 104 configured to generate comic content of the frames is included in the system 100.

A schematic block diagram of the proposed system 200 for browsing in a digital comic is depicted in FIG. 12. It comprises a browser 202 configured to present and traverse comic content of frames that form pages of a digital comic including one or more multi-storylines each including two or more storylines and to present selection elements in one or more frames allowing a user of the digital comic to select a storyline from among the two or more storylines of a multi-storyline associated with a frame containing selection elements. Further, a selecting unit 204 configured to allow a user to actuate a selection element when presented to thus select a storyline from among the two or more storylines of a multi-storyline is included in the system 200.

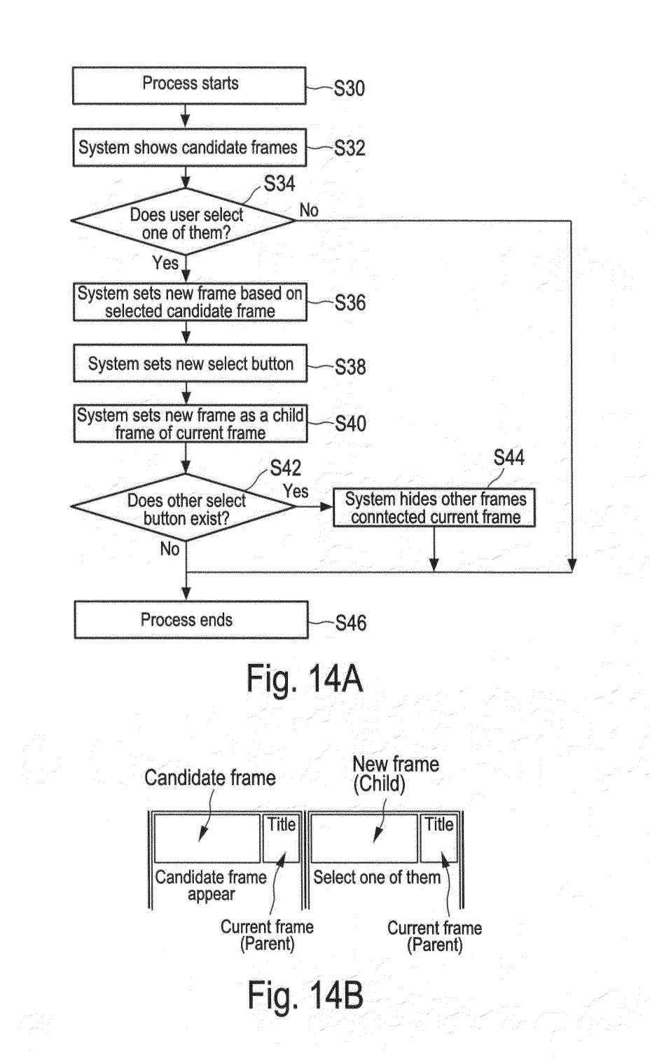

FIG. 13 shows a flow chart illustrating an embodiment of the main process for creating a digital comic. After starting the application (S10) the system displays a start frame (S12). If the user pushes the add button (S14) a new frame is created (S16). Alternatively, if a select button (i.e. a selection element) exists (S18) the system displays the related frame (S20). At the end the process returns to steps S14 or S18.

FIG. 14A shows a flow chart illustrating an embodiment of the steps for creating a new frame. FIG. 14B illustrates some terms used in the flow chart. After starting the process (S30) the system shows candidate frames (S32). If the user selects one of them (S34) the system sets a new frame based on the selected candidate frame (S36). Then, the system sets a new select button (S38). Then, the system sets a new frame as a child frame of the current frame (S40). If another select button exists (S42) the system hides other frames connected to the current frame (S44). Thereafter, in if no other select button exists, the process ends (S46).

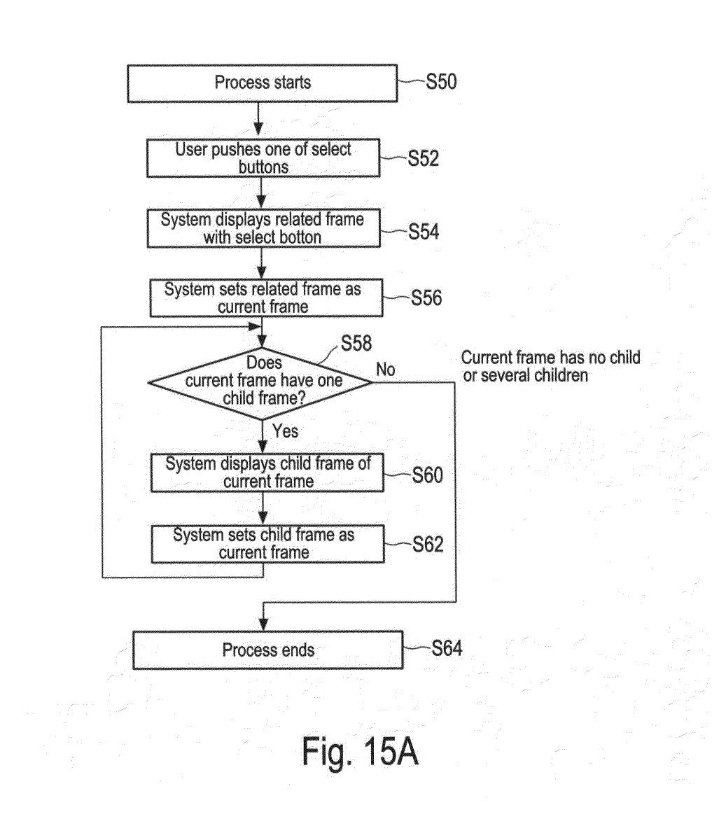

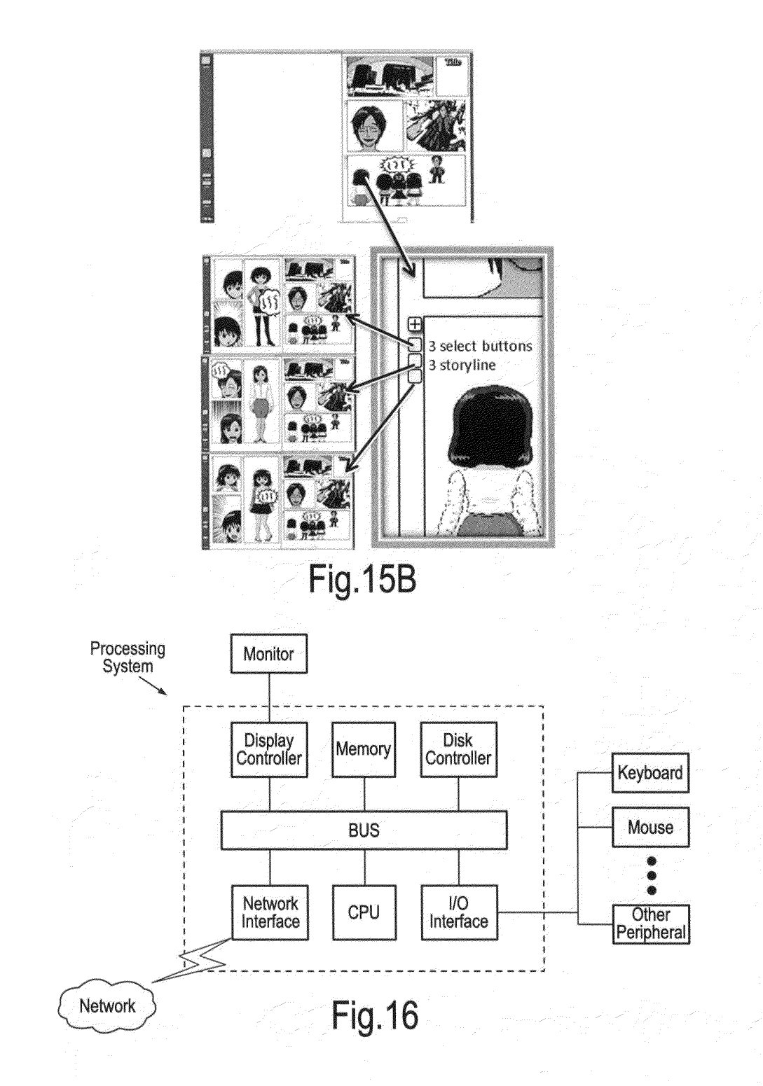

FIG. 15A shows a flow chart illustrating an embodiment of the steps for displaying a frame related to a selection element. FIG. 15B illustrates some terms used in the flow chart. After starting the process (S50) the user pushes one select button (S52) and the system a frame related with the pushed select button (S54). Then, the system sets the related frame as current frame (S56). If the current frame has one child frame (S58) the system displays the child frame of the current frame (S60) and sets the child frame as current frame (S62). Then the process returns to step S58. If the current frame has no child frame (S58) the process ends (S64).

In summary a new multi-storyline comic creation and comic browsing system and method have been described that provide and use multi-storyline comic books with unique interaction and format. The new concept and a user interface designed to realize the concept effectively are described. In a preferred embodiment other visualization techniques are used to provide more effective expression. Preferably, the proposed digital comic books have a tree structure, so it is possible to visualize a wide variety of information visualization methods. These methods are useful to see comic contents from different viewpoints.

FIG. 16 is a hardware diagram of a processing system embodying aspects of this disclosure, including aspects involving a computer utilized to implement the disclosed system and method. The processes, algorithms and electronically driven systems described herein can be implemented via a discrete control device or computing system consistent with the structure shown in FIG. 16. Such a system is described herein as a processing system.

As shown in FIG. 16, a processing system in accordance with this disclosure can be implemented using a microprocessor or its equivalent, such as a central processing unit (CPU) or at least one application specific processor ASP (not shown). The microprocessor utilizes a computer readable storage medium, such as a memory (e.g., ROM, EPROM, EEPROM, flash memory, static memory, DRAM, SDRAM, and their equivalents), configured to control the microprocessor to perform and/or control the processes and systems of this disclosure. Other storage mediums can be controlled via a controller, such as a disk controller, which can controls a hard disk drive or optical disk drive.

The microprocessor or aspects thereof, in an alternate embodiment, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The microprocessor can be a separate device or a single processing mechanism. Further, this disclosure can benefit from parallel processing capabilities of a multi-cored CPU.

In another aspect, results of processing or the input of data in accordance with this disclosure can be displayed via a display controller to a monitor. The display controller would then preferably include at least one graphic processing unit for improved computational efficiency. Additionally, an I/O (input/output) interface is provided for inputting data from a keyboard or a pointing device (not shown) for controlling parameters of the various processes and algorithms of this disclosure can be connected to the I/O interface to provide additional functionality and configuration options, or control display characteristics. Moreover, the monitor can be provided with a touch-sensitive interface to a command/instruction interface, and other peripherals can be incorporated, including a scanner or a web cam when image-based data entry is used.

The above-noted components can be coupled to a network, as shown in FIG. 16, such as the Internet or a local intranet, via a network interface for the transmission or reception of data, including controllable parameters. The network provides a communication path to the mobile device, which can be provided by way of packets of data. Additionally, a central BUS is provided to connect the above hardware components together and provides at least one path for digital communication there between.

The foregoing discussion discloses and describes merely exemplary embodiments of the present disclosure. As will be understood by those skilled in the art, the present disclosure may be embodied in other specific forms without departing from the spirit or essential characteristics thereof Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

As explained above, the elements of the disclosed devices, apparatus and systems may be implemented by corresponding hardware and/or software elements, for instance appropriated circuits. A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit includes the above-described hardware executing software.

1: A system for creating a digital comic, comprising
a page processor configured to generate frames and the layout of frames that form pages of a digital comic including one or more multi-storylines each including two or more storylines and to provide selection elements in one or more frames allowing a user of the digital comic to select a storyline from among the two or more storylines of a multi-storyline associated with a frame containing selection elements, and
an edit processor configured to generate comic content of the frames.

2: The system of claim 1, wherein the page processor is configured to provide addition elements in one or more frames allowing a user of the digital comic to add one or more storylines to a frame containing an addition element.

3: The system of claim 2, wherein the page processor is configured to automatically provide one or more selection elements to a frame when a multi-storyline is included in said frame.

4: The system of claim 1, wherein the page processor is configured to provide addition elements in one or more frames allowing a user of the digital comic to add one or more storylines to a frame containing an addition element.

5: The system of claim 1, wherein the page processor is configured to provide a user interface.

6. The system of claim 1, wherein the page processor is configured to provide selection elements and/or addition elements as buttons in a user interface provided by the page processor.

7: The system of claim 1, wherein the edit processor is configured to provide editing functions allowing a user to generate comic content of the frames.

8: A method for creating a digital comic, comprising
generating frames and the layout of frames that form pages of a digital comic including one or more multi-storylines each including two or more storylines,
providing selection elements in one or more frames allowing a user of the digital comic to select a storyline from among the two or more storylines of a multi-storyline associated with a frame containing selection elements, and
generating comic content of the frames.

9: A system for browsing in a digital comic, comprising
a browser configured to present and traverse comic content of frames that form pages of a digital comic including one or more multi-storylines each including two or more storylines and to present selection elements in one or more frames allowing a user of the digital comic to select a storyline from among the two or more storylines of a multi-storyline associated with a frame containing selection elements, and
a selecting unit configured to allow a user to actuate a selection element when presented to thus select a storyline from among the two or more storylines of a multi-storyline.

10: The system of claim 9, wherein the browser is configured to present one or more selection elements when one or more frames containing the presented comic content is associated with a multi-storyline.

11: The system of claim 9, wherein the browser provides a user interface allowing a user of the digital comic to present one or more frames.

12: The system of one of claim 11, wherein the user interface contains a graph layout and/or a tree map.

13: The system of claim 8, wherein the selecting unit comprises one or more of a computer mouse, a pointer, a touchpad, a remote control.

14: A method for browsing in a digital comic, comprising
presenting and/or traversing comic content of frames that form pages of a digital comic including one or more multi-storylines each including two or more storylines,
presenting selection elements in one or more frames allowing a user of the digital comic to select a storyline from among the two or more storylines of a multi-storyline associated with a frame containing selection elements, and
allowing a user to actuate a selection element when presented to thus select a storyline from among the two or more storylines of a multi-storyline.

15: A non-transitory computer-readable recording medium that stores therein a computer program product, which, when executed by a processor, causes the method according to claim 8 to be performed.

16: Digital comic comprising
comic content included in frames that form pages of a digital comic including one or more multi-storylines each including two or more storylines,
selection elements in one or more frames allowing a user of the digital comic to select a storyline from among the two or more storylines of a multi-storyline associated with a frame containing selection elements.

17: A non-transitory computer-readable recording medium that stores therein a digital comic according to claim 16.
